(19) United States
(12) Patent Application Publication
(10) Pub. No.: US 2026/0203826 A1
(43) Pub. Date: Jul. 16, 2026

(54) SYSTEMS AND METHODS FOR FEATURE EXTRACTION OF TELEMATICS DATA

(71) Applicant: Quanata, LLC, San Francisco, CA (US)

(72) Inventor: Gil Tamari, San Francisco, CA (US)

(73) Assignee: Quanata, LLC, San Francisco, CA (US)

(21) Appl. No.: 19/016,961

(22) Filed: Jan. 10, 2025

(51) Int. Cl. G06Q 40/08

(52) U.S. Cl. CPC G06Q 40/08

(57) ABSTRACT

A method for feature extraction from telematics data. The method includes obtaining telematics data for a plurality of trips for one or more drivers for a policy. The method also includes generating, using an automatic feature extraction encoder, respective latent representation embeddings each of the plurality of trips for the one or more drivers for the policy. The method additionally includes combining the respective latent representation embeddings for the plurality of trips to generate a combined embedding representation for the policy. The method further includes generating an output for the policy, using a supervised machine-learning model, based on inputs to the supervised machine-learning model comprising the combined embedding representation. Other embodiments are described.

### CROSS-REFERENCE TO RELATED APPLICATION

This application is related to U.S. patent application Ser. No. 18/243,440, filed Sep. 7, 2023, which is incorporated herein by reference in its entirety.

### FIELD OF THE DISCLOSURE

The application relates generally to feature extraction of telematics data.

### BACKGROUND OF THE DISCLOSURE

Driving behaviors of users may be predicted based on sufficient telematics data collected by one or more sensors of the mobile devices and/or vehicles. However, in some cases, there may not be sufficient telematics data of a user to predict driving behaviors associated with the user. Hence, it is desirable to develop more accurate techniques for predicting driving behaviors of users in a region that has insufficient trip data collected for users in the region. Additionally, conventional use of telematics data often is limited in its approaches to feature extraction.

### BRIEF DESCRIPTION OF THE DRAWINGS

FIG. 1 is a simplified diagram showing a method for determining predicted driving behaviors of a selected demographic group of users in a target region according to certain embodiments of the present disclosure.

FIGS. 2A-2C are a simplified diagram showing a method for determining predicted driving behaviors of a target user in a target region according to some embodiments of the present disclosure.

FIG. 3 is a simplified diagram showing a method for training a simulation model for predicting driving behaviors of a target user in a target region using a generative model (e.g., self-supervised learning or autoencoder algorithm) according to certain embodiments of the present disclosure.

FIG. 4 is an exemplary diagram illustrating a self-supervised learning model, according to certain embodiments of the present disclosure.

FIG. 5 is an exemplary diagram illustrating an autoencoder according to certain embodiments of the present disclosure.

FIG. 6 is an exemplary diagram illustrating predicting driving behavior of a targeted demographic group of users in Arizona based at least in part upon existing trip data of a similar demographic group of users in Rhode Island according to certain embodiments of the present disclosure.

FIG. 7 is a simplified diagram showing a system for determining predicted driving behaviors of a targeted demographic group of users in a target region according to certain embodiments of the present disclosure.

FIG. 8 is a simplified diagram showing components of a method for generating an output from raw trip data using automatic feature extraction, according to certain embodiments of the present disclosure.

FIG. 9 is a simplified diagram showing components of a method for generating a clustering of trips based on raw trip data, according to certain embodiments of the present disclosure.

FIG. 10 is a simplified diagram showing a method for performing feature extraction of telematics data, according to certain embodiments of the present disclosure.

### DETAILED DESCRIPTION OF THE DISCLOSURE

Some embodiments of the present disclosure are directed to advance feature extraction from telematics data. More particularly, certain embodiments of the present disclosure provide methods and systems for feature extraction from telematics data to perform risk assessment and/or for other use cases. Some embodiments of the present disclosure are directed to determining predicted driving behaviors of a user in a target region. More particularly, certain embodiments of the present disclosure provide methods and systems for determining predicted driving behaviors of a target user in a target region by generating synthetic trips for the target user in a targeted region based at least in part upon reference trips taken by one or more reference users in a reference region. Merely by way of example, the present disclosure has been applied to determining driving behaviors of a target user of a particular sociodemographic group in a target region based at least in part upon driving behaviors of reference users of a similar sociodemographic group in the reference region. But it would be recognized that the present disclosure has much broader range of applicability.

### I. Methods for Determining Predicted Driving Behaviors of a Target User in a Target Region

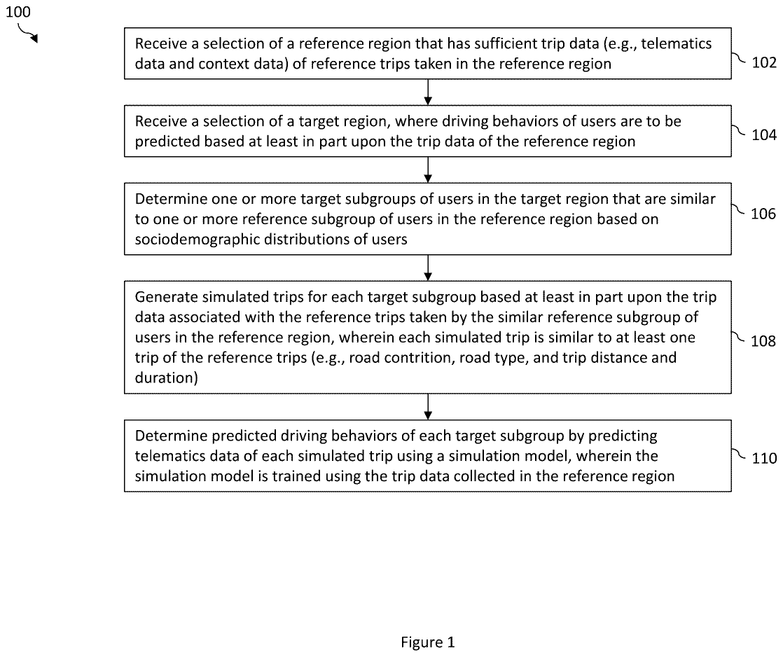

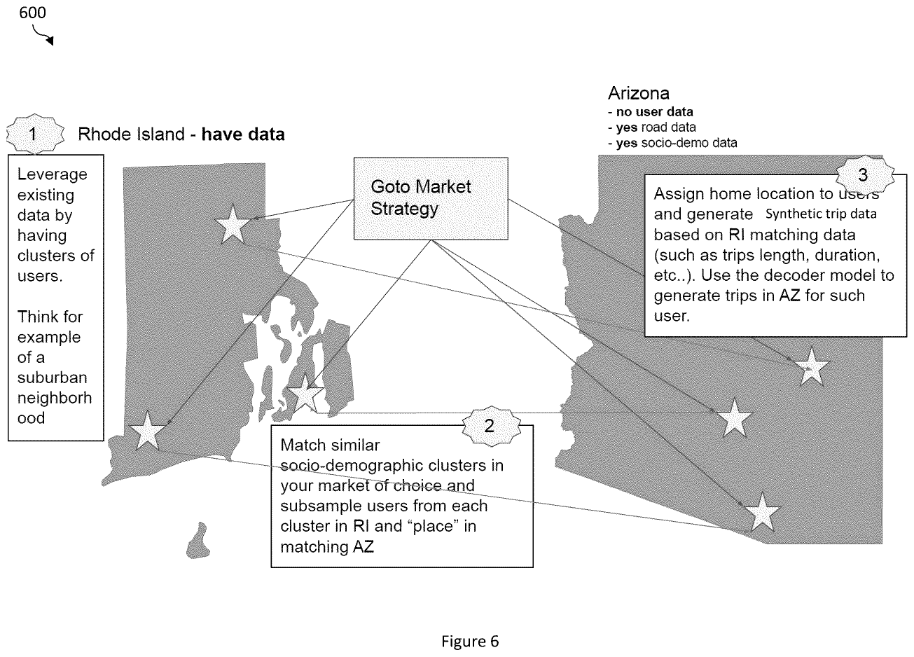

FIG. 1 is a simplified diagram showing a method 100 for determining predicted driving behaviors of a selected demographic group of users in a target region according to certain embodiments of the present disclosure. One of ordinary skill in the art would recognize many variations, alternatives, and modifications. In some embodiments, the method 100 is performed by a computing device (e.g., a server 706). In certain embodiments, the method 100 is used to predict driving behavior of a targeted demographic group of users in a target region such as Arizona based at least in part upon existing trip data of a similar demographic group of reference users in a reference region such as Rhode Island, as shown in FIG. 6.

The processes described herein provide solutions to allow for predicting driving behavior of a target user or users in a selected region where there is no or inadequate data, such as telematics data, to predict how the target user will drive in the selected region. Knowing driving behavior may have direct to correlation on vehicles used by the user such as wear and tear, maintenance costs and the like. By matching target users with reference users (in a reference region) having similar characteristics (e.g., sociodemographic) along with using the reference users' data such as telematics data, in a generative or simulation model, a prediction of how the target user will likely drive in a reference region can be projected. This information may then be used for various purposes such as predicting insurance costs for the target user, maintenance costs of a vehicle, vehicle life, and the like.

The method 100 includes process 102 for receiving a selection of a reference region, process 104 for receiving a selection of a target region, process 106 for determining one or more target subgroup of users in the target region that are similar to one or more reference subgroups of users in the reference region such as based on sociodemographic distributions of users, process 108 for generating synthetic trips for each target subgroup of users based at least in part upon the trip data associated with the reference trips taken by the similar reference subgroup of users in the reference region, and process 110 for determining predicted driving behaviors of each target subgroup of users by predicting telematics data of each synthetic trip using a simulation model.

Specifically, at the process 102, a reference region (e.g., Rhode Island) is selected based on an amount of trip data collected in the corresponding reference region. A reference region is selected if the reference region has sufficient trip data (e.g., telematics data and context data) of reference trips that a reference group of users have taken in the corresponding reference region. For example, the trip data of reference trips may be sufficient if an amount of trip data exceeds a predetermined threshold. Alternatively or additionally, the trip data of reference trips may be sufficient if a number of reference trips exceeds a predetermined threshold. Alternatively or additionally, the trip data of reference trips may be sufficient if a total distance of reference trips exceeds a predetermined threshold. In other embodiments, the trip data of reference trips may be sufficient if a total time of reference trips exceeds a predetermined threshold. A predetermined threshold may be 50 data points/miles, 100 data points/miles or 200 data points/miles or a 1000 data points/miles and the like.

In the illustrative embodiment, the trip data includes telematics data and context data associated with reference trips. The telematics data is collected during reference trips of a user and indicates driving behaviors of the user during the reference trips. As an example, the driving behavior represents a manner in which the user has operated a vehicle. For example, the user driving behavior indicates the user's driving habits and/or driving patterns, such as speed, braking, turning and the like. The telematics data may be collected from one or more sensors associated with a vehicle, satellite, cameras (including street cameras), and/or a user's mobile device. For example, the one or more sensors include any type and number of accelerometers, gyroscopes, magnetometers, location sensors (e.g., GPS sensors), and/or any other suitable sensors that measure the state and/or movement of the vehicle and/or the mobile device. In certain embodiments, the telematics data may be collected continuously or at predetermined time intervals, such as 1 ms (milliseconds), 100 ms, 1 second, 2 second and the like.

In the illustrative embodiment, the context data includes road data, user data, and/or world data. The road data associated with a reference trip includes information about one or more roads taken during the reference trip. For example, the road data includes a type of the road (e.g., highway, freeway, toll, local, or parking lot), a road map (e.g., curvature, incline, gradient, elevation, direction, and/or a number of lanes), and/or road conditions (e.g., road moisture, traffic). The user data associated with a reference trip of a user includes any socio-demographic information or characteristics of the user. For example, the user data includes age, race, height, weight, ethnicity, gender, marital status, income, education, employment, and/or credit score. The world data associated with a reference trip includes an indication whether the reference trip was taken on a holiday, a weather condition during the reference trip, and/or an indication of when the reference trip was taken (e.g., time of day, day of week, day of month, and/or month of year). In other words, the reference region trip data (e.g., telematics, context) provides a basis for predicting driving behaviors of a target region trip data (e.g., telematics, context) that is similar to the reference region.

At the process 104, a target region is a region where there is insufficient trip data of users that have been collected. As such, a target region is selected to predict driving behaviors of users in the target region at least in part upon the trip data collected from the reference region.

At the process 106, sociodemographic distributions of the users in the reference region and the target region are determined. For example, the sociodemographic variables include age, gender, social class, education level, migration background, relationship status, parental status, employment status, and town size. Sociodemographic studies have shown that occupational status and education level seems to be important determination of driver injury risk. The users in the target region that have similar sociodemographic data are assigned to the same cluster. The geographical area associated with each sociodemographic cluster of users is referred to as a target subgroup of users in the target region. Similarly, the users in the reference region that have similar sociodemographic data are assigned to the same cluster. The geographical area associated with each sociodemographic cluster of users is referred to as a reference subgroup of users in the reference region. Subsequently, based on the sociodemographic clusters in the target and reference regions, the server 706 determines if there is a reference subgroup in the reference region that is similar to a target subgroup in the target region. In other words, the server 706 matches the reference subgroups to the target subgroups based on the sociodemographic variables, which may be 3, 5, 10 variables and the like.

According to some embodiments, a particular sociodemographic group of users (i.e., the target subgroup) in the target region may be selected. Based on the selected sociodemographic group, the server 706 may determine one or more users (i.e., the reference subgroup) in the reference region that have similar sociodemographic variables as the selected sociodemographic group of users in the target region.

At the process 108, for each target subgroup of users that has a similar reference subgroup, one or more synthetic trips are generated based at least in part upon the trip data associated with reference trips taken by the similar reference subgroup of users in the reference region. More specifically, one or more synthetic trips are generated for each user of the target subgroup. For example, a synthetic trip is generated for a user of the target subgroup based on road condition, road type, and trip distance and/or duration of a reference trip taken by a user of the similar reference subgroup. In other words, a synthetic trip includes road condition(s), road type(s), and trip distance and/or duration similar to at least one reference trip taken by a user of the similar reference subgroup. According to some embodiments, a number of generated synthetic trips is the same or even higher or lower as a number of reference trips taken by the users of the similar reference subgroup in the reference region.

At the process 110, for each synthetic trip, telematics data is predicted using a simulation model. For example, the simulation model is generated using a generative model (e.g., self-supervised learning or autoencoder algorithm) and is trained using the trip data collected in the reference region. More specifically, the trip data is associated with the reference trips taken by all users in the reference region. However, in some embodiments, a simulation model may be trained using a subset of the trip data collected in the reference region. For example, a simulation model may be trained using the trip data of reference trips taken by the similar reference subgroup of users in the reference region.

Based at least in part upon the predicted telematics data, driving behaviors of the target subgroup is predicted for the target region. As an example, the driving behavior represents a manner in which a user has operated a vehicle. For example, the user driving behavior indicates the driving habits and/or driving patterns of the user. In other words, driving habits and/or driving patterns of a particular sociodemographic group of users in the target region is predicted based driving habits and/or driving patterns of a similar sociodemographic group of users in the reference region.

Although the above has been shown using a selected group of processes for the method, there can be many alternatives, modifications, and variations. For example, some of the processes may be expanded and/or combined. Other processes may be inserted to those noted above. Depending upon the embodiment, the sequence of processes may be interchanged with others or replaced. For example, although the method 100 is described as performed by the computing device above, some or all processes of the method are performed by any computing device or a processor directed by instructions stored in memory. As an example, some or all processes of the method are performed according to instructions stored in a non-transitory computer-readable medium.

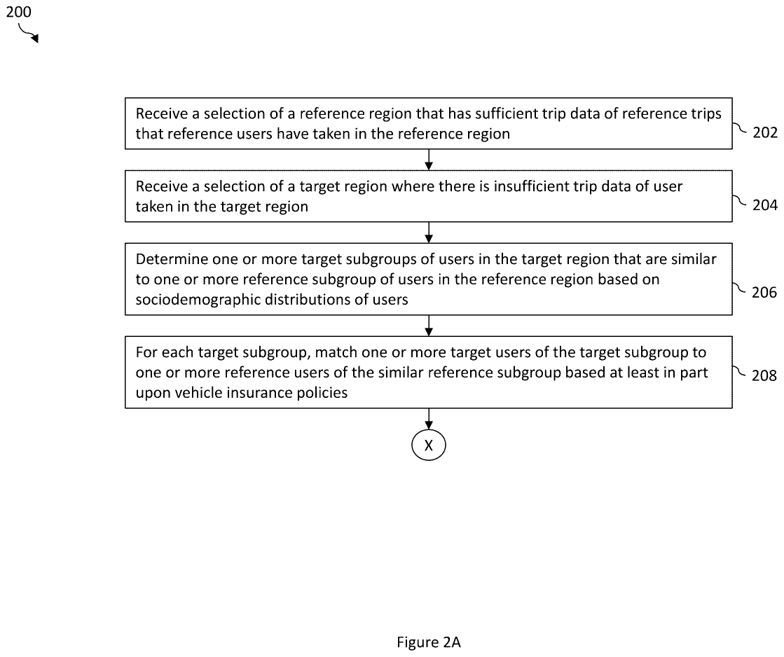

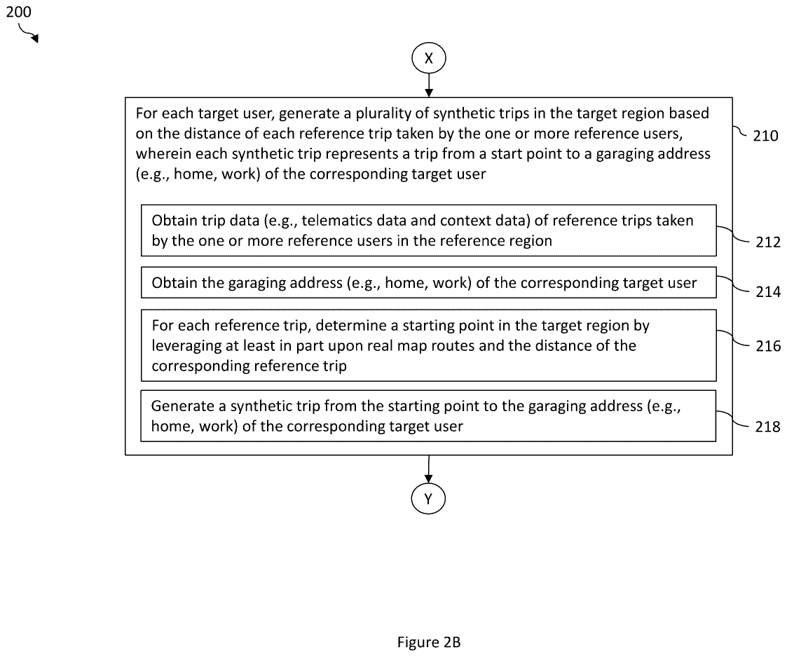

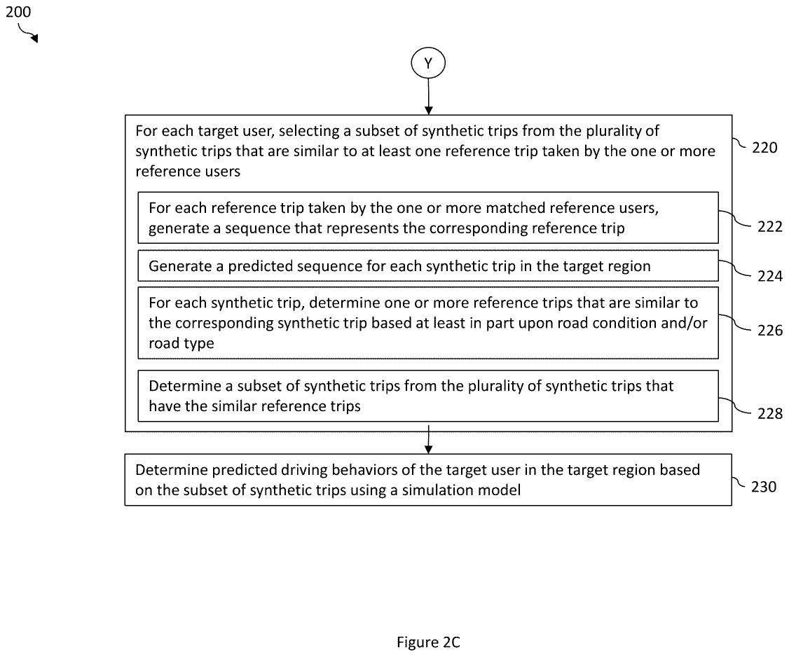

FIGS. 2A, 2B, and 2C are simplified diagrams showing a method 200 for determining predicted driving behaviors of a target user in a target region according to certain embodiments of the present disclosure. This diagram is merely an example, which should not unduly limit the scope of the claims. One of ordinary skill in the art would recognize many variations, alternatives, and modifications. In the illustrative embodiment, the method 200 is performed by a computing device (e.g., a server 706).

The method 200 includes process 202 for receiving a selection of a reference region, process 204 for receiving a selection of a target region, process 206 for determining one or more target subgroup of users in the target region that are similar to one or more reference subgroups of users in the reference region such as based on sociodemographic distributions of users, process 208 for matching one or more target users of the target subgroup to one or more reference users of the similar reference subgroup based on vehicle insurance policies, process 210 for generating a plurality of synthetic trips in the target region for each target user based on the distance of each reference trip taken by the one or more reference users, process 220 for selecting a subset of synthetic trips from the plurality of synthetic trips that are similar to at least one reference trip taken by the one or more reference users, and process 230 for determining predicted driving behaviors of the target user based on the subset of synthetic trips using a simulation model.

Specifically, at the process 202, a reference region is selected based on an amount of trip data collected in the corresponding reference region. A reference region is selected if the reference region has sufficient trip data (e.g., telematics data and context data) of reference trips that users have taken in the corresponding reference region. For example, the trip data of reference trips may be sufficient if an amount of trip data exceeds a predetermined threshold. Alternatively or additionally, the trip data of reference trips may be sufficient if a number of reference trips exceeds a predetermined threshold. Alternatively or additionally, the trip data of reference trips may be sufficient if a total distance of reference trips exceeds a predetermined threshold. In other embodiments, the trip data of reference trips may be sufficient if a total time of reference trips exceeds a predetermined threshold. A predetermined threshold may be 50 data points/miles, 100 data points/miles or 200 data points/miles or a 1000 data points/miles and the like.

According to some aspects, the server 706 may determine whether the selected reference region has a sufficient amount of trip data to proceed with the process 204. If the selected reference region has an insufficient amount of trip data to proceed with the remaining processes of method 200, the server 706 may notify a provider to choose a different reference region and/or provide an alternative reference region(s) that has a sufficient amount of trip data that may be selected. According to some embodiments, a particular target user in the target region may be selected.

In the illustrative embodiment, the trip data includes telematics data and context data associated with reference trips. The telematics data is collected during reference trips of a user and indicates driving behaviors of the user during the reference trips. As an example, the driving behavior represents a manner in which the user has operated a vehicle. For example, the user driving behavior indicates the user's driving habits and/or driving patterns, such as speed, braking, turning and the like. The telematics data may be collected from one or more sensors associated with a vehicle, satellite, cameras (including street cameras), and/or a user's mobile device. For example, the one or more sensors include any type and number of accelerometers, gyroscopes, magnetometers, location sensors (e.g., GPS sensors), and/or any other suitable sensors that measure the state and/or movement of the vehicle and/or the mobile device. In certain embodiments, the telematics data may be collected continuously or at predetermined time intervals, such as 1 ms, 100 ms, 1 second, 2 second and the like.

In the illustrative embodiment, the context data includes road data, user data, and/or world data. The road data associated with a reference trip includes information about one or more roads taken during the reference trip. For example, the road data includes a type of the road (e.g., highway, freeway, toll, local, or parking lot), a road map (e.g., curvature, incline, gradient, elevation, direction, and/or a number of lanes), and/or road conditions (e.g., road moisture, traffic). The user data associated with a reference trip of a user includes any socio-demographic information or characteristics of the user. For example, the user data includes age, race, height, weight, ethnicity, gender, marital status, income, education, employment, and/or credit score. The world data associated with a reference trip includes an indication whether the reference trip was taken on a holiday, a weather condition during the reference trip, and/or an indication of when the reference trip was taken (e.g., time of day, day of week, day of month, and/or month of year). In other words, the reference region trip data (e.g., telematics, context) provides a basis for predicting driving behaviors of a target region trip data (e.g., telematics, context) that is similar to the reference region.

At the process 204, a target region is a region where there is insufficient trip data of users that have been collected. As such, a target region is selected to predict driving behaviors of users in the target region at least in part upon the trip data collected from the reference region.

At the process 206, sociodemographic distributions of the users in the reference region and the target region are determined. For example, the sociodemographic variables include age, gender, social class, education level, migration background, relationship status, parental status, employment status, and town size. Sociodemographic studies have shown that occupational status and education level seems to be important determination of driver injury risk. The users in the target region that have similar sociodemographic data are assigned to the same cluster. The geographical area associated with each sociodemographic cluster of users is referred to as a target subgroup of users in the target region. Similarly, the users in the reference region that have similar sociodemographic data are assigned to the same cluster. The geographical area associated with each sociodemographic cluster of users is referred to as a reference subgroup of users in the reference region. Subsequently, based on the sociodemographic clusters in the target and reference regions, the server 706 determines if there is a reference subgroup in the reference region that is similar to a target subgroup in the target region. In other words, the server 706 matches the reference subgroups to the target subgroups based on the sociodemographic variables, which may be 3, 5, 10 variables and the like.

According to some embodiments, a particular sociodemographic group of users (i.e., the target subgroup) in the target region may be selected. Based on the selected sociodemographic group, the server 706 may determine one or more users (i.e., the reference subgroup) in the reference region that have similar sociodemographic variables as the selected sociodemographic group of users in the target region.

At the process 208, for each target subgroup, one or more target users of the target subgroup are matched to one or more reference users of the similar reference subgroup based at least in part upon vehicle insurance policies purchased by the one or more target users and the one or more reference users. For example, the server 706 may determine one or more target users of the target subgroup that have the same vehicle insurance policy that, for example, includes similar vehicles and coverage limits as one or more reference users of the similar reference subgroup. It should be appreciated that the target users are a subset of the target subgroup of users that have been matched to at least one user of the similar reference subgroup, also referred to as a reference user, based at least in part upon vehicle insurance policies. Similarly, the reference users (also referred to as matched reference users) are a subset of the similar reference subgroup of users that have been matched to at least one target user of the target subgroup based at least in part upon vehicle insurance policies. It should be appreciated that, in some embodiments, the process 208 may be optional.

At the process 210, a plurality of synthetic trips for each target user in the target region are generated. Each synthetic trip represents a trip from a starting point to a garaging address (e.g., home or work) of the corresponding target user. Additionally, each synthetic trip is generated based on the distance of each reference trip of the one or more reference trips taken by the one or more matched reference users. In other words, each synthetic trip has the same or similar distance as at least one reference trip taken by the one or more matched reference users.

To do so, at process 212, trip data of reference trips taken by the one or more matched reference users in the reference region is obtained. The trip data includes telematics data and context data related to the reference trips. At process 214, the garaging address of the corresponding target user is obtained. For example, the garaging address is a location where the corresponding target user's vehicle is usually parked majority of the time or is primarily parked overnight. In the illustrative embodiment, the garaging address is obtained from the vehicle insurance policy of the corresponding target user.

At process 216, for each reference trip, a starting point in the target region is determined by leveraging at least in part upon a map and the distance of the reference trip. According to some embodiments, the duration of the reference trip may be also considered. In other words, the starting point is a random location in the target region, which has been selected by traversing on the map (e.g., OpenStreetMap) from the garaging address to obtain a synthetic trip based on the distance of the reference trip.

At process 218, a synthetic trip is generated from the starting point to the garaging address of the corresponding target user. It should be appreciated that a synthetic trip is generated for each reference trip. In the illustrative embodiment, the processes 214-218 are repeated for each reference trip of the reference trips taken by the one or more matched reference users.

At the process 220, for each target user, a subset of the synthetic trips from the plurality of synthetic trips of the corresponding target user are selected. The selected synthetic trips are similar to at least one reference trip taken by the one or more matched reference users.

To do so, at process 222, for each reference trip taken by the one or more matched reference users, a sequence that represents the corresponding reference trip is generated. The sequence of a reference trip indicates different road segments of the reference trip. Subsequently or simultaneously, at process 224, a predicted sequence for each synthetic trip in the target region is generated. The predicted sequence indicates different road segments of the corresponding synthetic trip. According to certain embodiments, the process 222 may be performed subsequent to process 224.

At process 226, for each synthetic trip, one or more reference trips that are similar to the corresponding synthetic trip are determined. For example, a reference trip may be determined to be similar to the synthetic trip based at least in part upon road condition(s) and/or road type(s) using various similarity detection techniques. The similarity detection techniques may include edit-distance, representation cosine similarity, and/or weight-based ordinal similarity.

At process 228, a subset of synthetic trips from the plurality of synthetic trips are determined, wherein the subset of synthetic trips includes one or more synthetic trips that have one or more similar reference trips. In other words, in one embodiment, each synthetic trip of the subset of synthetic trips includes road condition(s), road type(s), and trip distance similar to at least one reference trip taken by the matched reference user of the similar reference subgroup.

At the process 230, predicted driving behaviors of the target user in the target region is determined based on the subset of the synthetic trips using a simulation model. For example, the simulation model is generated using a generative model (e.g., self-supervised learning or autoencoder algorithm) and is trained using trip data collected in the reference region. In the illustrative embodiment, a simulation model may be trained using trip data of reference trips taken by the similar reference subgroup of users in the reference region. For example, the trip data may be limited to the similar reference trips that are similar to at least one synthetic trip of the target user, as described in the process 228. Additionally, according to some embodiments, the trip data may further include more trip data associated with the reference trips taken by the one or more matched reference users in the reference region. As described above, the matched reference users have the similar sociodemographic variables and vehicle insurance policy. Additionally, according to certain embodiment, the trip data may further include one or more reference trips taken by all the reference users of the reference subgroup who have the similar sociodemographic variables. Alternatively, according to some embodiments, the simulation model may be trained using all trip data collected in the reference region.

Accordingly, using the simulation model, driving behaviors of each target user of the target subgroup is predicted for the target region. As an example, the driving behavior represents a manner in which the target user has operated a vehicle. For example, the target user driving behavior indicates the driving habits and/or driving patterns of the target user. In other words, driving habits and/or driving patterns of each target user of a particular sociodemographic group in the target region is predicted based on driving habits and/or driving patterns of one or more reference users of a similar sociodemographic group in the reference region that hold the same vehicle insurance policy.

According to some embodiments, receiving a selection of a reference region in the process 102 as shown in FIG. 1 is performed by the process 202 as shown in FIG. 2. According to certain embodiments, receiving a selection of a target region in the process 104 as shown in FIG. 1 is performed by the process 204 as shown in FIG. 2. According to some embodiments, determining one or more target subgroup of users in the target region that are similar to one or more reference subgroups of users in the reference region such as based on sociodemographic distributions of users in the process 106 as shown in FIG. 1 is performed by the process 206 as shown in FIG. 2. According to certain embodiments, generating synthetic trips for each target subgroup of users based at least in part upon the trip data associated with the reference trips taken by the similar reference subgroup of users in the reference region in the process 108 as shown in FIG. 1 is performed by the processes 208-218 as shown in FIG. 2. According to some embodiments, determining predicted driving behaviors of each target subgroup of users by predicting telematics data of each synthetic trip using a simulation model in the process 110 as shown in FIG. 1 is performed by the processes 220-230 as shown in FIG. 2.

Although the above has been shown using a selected group of processes for the method, there can be many alternatives, modifications, and variations. For example, some of the processes may be expanded and/or combined. Other processes may be inserted to those noted above. Depending upon the embodiment, the sequence of processes may be interchanged with others or replaced. For example, although the method 200 is described as performed by the computing device above, some or all processes of the method are performed by any computing device or a processor directed by instructions stored in memory. As an example, some or all processes of the method are performed according to instructions stored in a non-transitory computer-readable medium.

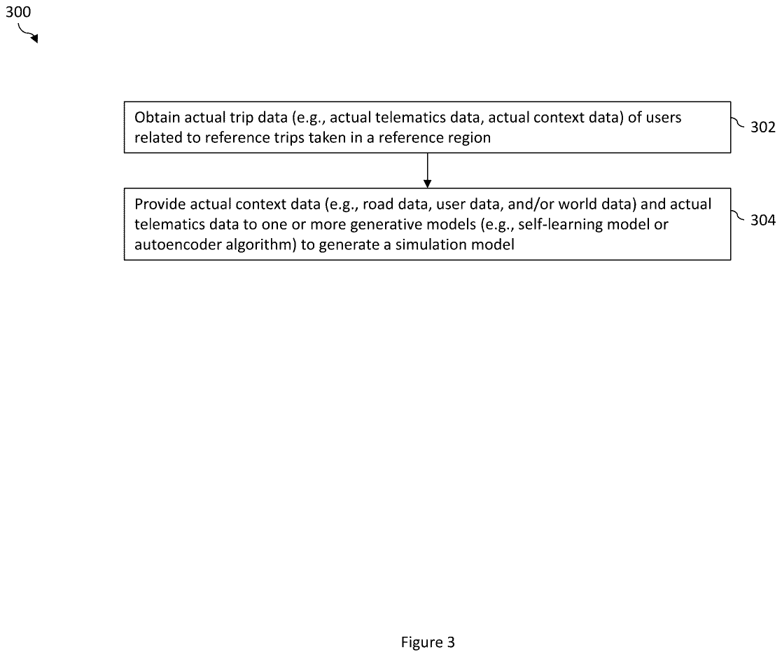

FIG. 3 is a simplified diagram showing a method 300 for training a simulation model for predicting driving behaviors of a target user in a target region using a generative model according to certain embodiments of the present disclosure. This diagram is merely an example, which should not unduly limit the scope of the claims. One of ordinary skill in the art would recognize many variations, alternatives, and modifications. In the illustrative embodiment, the method 300 is performed by a computing device (e.g., a server 706).

The method 300 includes process 302 for obtaining an actual trip data of users related to reference trips taken in a reference region, and process 304 for providing actual trip data to generated using a generative model (e.g., self-supervised learning or autoencoder algorithm) to generate a simulation model.

Specifically, at the process 302, the actual trip data of users in a particular reference region is obtained. For example, the actual trip data includes actual telematics data and actual context data associated with one or more reference trips collected in the reference region. The context data includes road data, user data, and/or world data. The road data associated with a reference trip includes information about one or more roads taken during the reference trip. For example, the road data includes a type of the road (e.g., highway, freeway, toll, local, or parking lot), a road map (e.g., curvature, incline, gradient, elevation, direction, and/or a number of lanes), and/or road conditions (e.g., road moisture, traffic). The user data associated with a reference trip of a user includes any socio-demographic information or characteristics of the user. For example, the user data includes age, race, height, weight, ethnicity, gender, marital status, income, education, employment, and/or credit score. The world data associated with a reference trip includes an indication whether the reference trip was taken on a holiday, a weather condition during the reference trip, and/or an indication of when the reference trip was taken (e.g., time of day, day of week, day of month, and/or month of year). In other words, the reference region trip data (e.g., telematics, context) provides a basis for predicting driving behaviors of a target region trip data (e.g., telematics, context) that is similar to the reference region.

Various set of trip data may be used to train the simulation model. For example, a simulation model may be customized for each target user of a particular sociodemographic group in a target region. To do so, the trip data may include one or more reference trips collected in the reference region that are similar to at least one synthetic trip of the corresponding target user. Additionally, according to some embodiments, the trip data may further include more trip data associated with the reference trips taken by the one or more matched reference users in the reference region. As described above, the matched reference users have the similar sociodemographic variables and vehicle insurance policy as the corresponding target user. Additionally, according to certain embodiment, the trip data may further include one or more reference trips taken by all the reference users of the reference subgroup who have the similar sociodemographic variables. Alternatively, according to some embodiments, the simulation model may be trained using all trip data collected in the reference region.

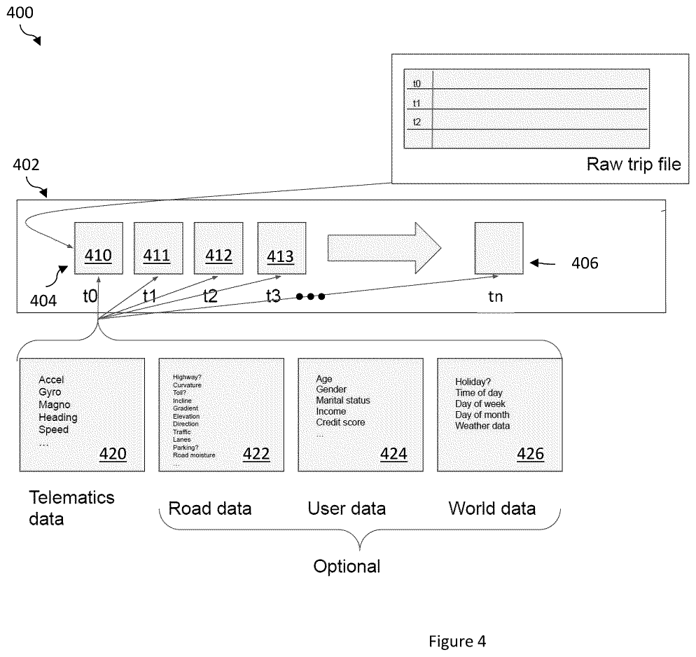

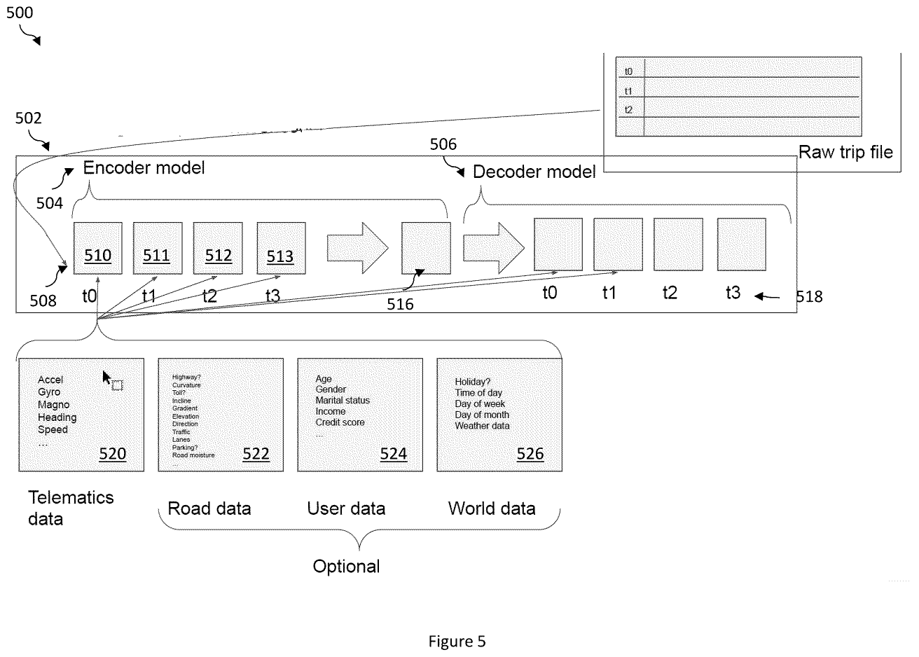

At the process 304, according to some embodiments, the simulation model may be a self-supervised learning model. For example, a self-supervised learning algorithm may be trained using the actual context data and the actual telematics data of users related to reference trips taken in a reference region as illustrated in an exemplary diagram shown in FIG. 4. Alternatively, according to certain embodiments, the simulation model may be an autoencoder (e.g., a temporal autoencoder). For example, the autoencoder may be trained using the actual context data and the actual telematics data of users related to reference trips taken in a reference region as illustrated in an exemplary diagram shown in FIG. 5.

Although the above has been shown using a selected group of processes for the method, there can be many alternatives, modifications, and variations. For example, some of the processes may be expanded and/or combined. Other processes may be inserted to those noted above. Depending upon the embodiment, the sequence of processes may be interchanged with others or replaced. For example, although the method 200 is described as performed by the computing device above, some or all processes of the method are performed by any computing device or a processor directed by instructions stored in memory. As an example, some or all processes of the method are performed according to instructions stored in a non-transitory computer-readable medium.

### II. Systems for Feature Extraction and/or Training A Simulation Model

FIG. 4 is a simplified diagram showing a method 400 for using a self-supervised learning model 402 for feature extraction and/or predicting driving behaviors of a target user in a target region using a self-supervised learning algorithm, according to certain embodiments of the present disclosure. Self-supervised learning of method 400 is a machine learning process where the simulation model trains itself to learn one part of the input from another part of the input.

In the illustrative embodiment, trip data associated with reference trips of users is used as input data 404 that include one or more data set 410, 411, 412, 413 to train the self-supervised learning model 402. For example, the data set (410-413 . . . ) includes telematics data 420 collected during reference trips and may include acceleration, heading, speed, gyroscope data and the like. As described above, the telematics data associated with the reference trips indicates driving behaviors of the corresponding user during the reference trips. As an example, the driving behavior represents a manner in which the corresponding user has operated a vehicle such as driving habits and/or driving patterns. The telematics data may be collected from one or more sensors associated with a vehicle and/or a user's mobile device. For example, the one or more sensors include any type and number of accelerometers, gyroscopes, magnetometers, location sensors (e.g., GPS sensors), and/or any other suitable sensors that measure the state and/or movement of the vehicle and/or the mobile device. In certain embodiments, the telematics data may be collected continuously or at predetermined time intervals.

According to some embodiments, the trip data may further include the context data associated with the reference trips and is also used as input data 404 via data sets (410-413 . . . ) to train the self-supervised learning model 402. In many embodiments, self-supervised learning model 402 can be an auto-regressive and/or causal language model. The context data provides further information associated with or related to the reference trips. For example, the context data may include road data 422, user data 424, and/or world data 426. The road data 422 associated with a reference trip includes information about one or more roads taken during the reference trip. For example, the road data 422 includes a type of the road (e.g., highway, freeway, toll, local, or parking lot), a road map (e.g., curvature, incline, gradient, elevation, direction, and/or a number of lanes), and/or road conditions (e.g., road moisture, traffic). The user data 424 associated with each reference trip of a user includes any socio-demographic information or characteristics of the user. For example, the user data 424 includes age, race, height, weight, ethnicity, gender, marital status, income, education, employment, and/or credit score. The world data 426 associated with each reference trip includes an indication whether the reference trip was taken on a holiday, a weather condition during the reference trip, and/or an indication of when the reference trip was taken (e.g., time of day, day of week, day of month, and/or month of year).

The method 400 includes the input data 404 (e.g., raw trip data at times t₀, t₁, t₂, t₃ . . . ) is inputted to the self-supervised learning model 402 to predict trip data 406 (e.g., at time tₙ) using a self-supervised learning technique. The self-supervised learning model 402 learns how to analyze raw input data 404 to, for example, identify one or more patterns in driving behavior of a user and/or extract one or more features associated with driving behavior of a user based on the trip data of the corresponding user.

It should be appreciated that the method 400 is merely an example, which should not unduly limit the scope of the claims. One of ordinary skill in the art would recognize many variations, alternatives, and modifications. In the illustrative embodiment, components of the method 400 are inputted into a computing device (e.g., a server 706) in order to receive a predicted trip data 406.

FIG. 5 is a simplified diagram showing components of method 500 for using an autoencoder 502 (e.g., a temporal autoencoder) for feature extraction and/or predicting driving behaviors of a target user in a target region using according to certain embodiments of the present disclosure. For example, the autoencoder of method 500 is a type of deep learning algorithm that is designed to receive an input and transform it into a different representation. More specifically, the autoencoder learns how to transform input data (e.g., by an encoder model 504 of the autoencoder 502) and to recreate the input data from an encoded representation (e.g., by a decoder model 506 of the autoencoder 502).

In the illustrative embodiment, trip data associated with reference trips of users is used as input data 508 that include one or more data sets 510, 511, 512, 513 to train the autoencoder 502. For example, the data set (510-513 . . . ) includes telematics data 520 collected during reference trips and may include acceleration, heading, speed, gyroscope data and the like. As described above, the telematics data associated with the reference trips indicates driving behaviors of the corresponding user during the reference trips. As an example, the driving behavior represents a manner in which the corresponding user has operated a vehicle such as driving habits and/or driving patterns. The telematics data may be collected from one or more sensors associated with a vehicle, satellite, cameras (including street cameras), and/or a user's mobile device. For example, the one or more sensors include any type and number of accelerometers, gyroscopes, magnetometers, location sensors (e.g., GPS sensors), and/or any other suitable sensors that measure the state and/or movement of the vehicle and/or the mobile device. In certain embodiments, the telematics data may be collected continuously or at predetermined time intervals, such as 1 ms, 100 ms, 1 second, 2 second and the like.

According to some embodiments, the trip data may further include the context data associated with the reference trips and is also used as input data 508 via data set (510-513 . . . ) to train the autoencoder 502. In many embodiments, autoencoder 502 can be a temporal autoencoder. The context data provides further information associated with or related to the reference trips. For example, the context data may include road data 522, user data 524, and/or world data 526. The road data associated with a reference trip includes information about one or more roads taken during the reference trip. For example, the road data 522 includes a type of the road (e.g., highway, freeway, toll, local, or parking lot), a road map (e.g., curvature, incline, gradient, elevation, direction, and/or a number of lanes), and/or road conditions (e.g., road moisture, traffic). The user data 524 associated with each reference trip of a user includes any socio-demographic information or characteristics of the user. For example, the user data 524 includes age, race, height, weight, ethnicity, gender, marital status, income, education, employment, and/or credit score. The world data 526 associated with each reference trip includes an indication whether the reference trip was taken on a holiday, a weather condition during the reference trip, and/or an indication of when the reference trip was taken (e.g., time of day, day of week, day of month, and/or month of year).

The method 500 includes the raw input data 508 (e.g., raw trip data at times t₀, t₁, t₂, t₃) are inputted to the autoencoder 502 and is transformed into an encoded representation 516 by the encoder model 504. The decoder model 506 is configured to generate reconstructed trip data 518 (e.g., trip data at times t₀, t₁, t₂, t₃) from the encoded representation 516. During this process, the autoencoder 502 learns how to analyze raw input data 508 to, for example, identify one or more patterns in driving behavior of a user and/or extract one or more features associated with driving behavior of a user based on the trip data of the corresponding user.

In some embodiments, attention mechanisms can be incorporated into the autoencoders 502 (e.g., the temporal autoencoder), such as at each data set (e.g., 510, 511, 512, 513) for respective times for the trip data. In some cases attention can be used at encoded representation 516 and/or reconstructed trip data 518. For example, in some embodiments, attention may be applied in the encoder to generate context vectors. The encoder may process the input sequence and produce hidden states for each time step. An attention mechanism may then compute weights for these hidden states, allowing the model to focus on relevant parts of the input when creating a context vector. In some embodiments, attention may also be used in the decoder. As the decoder generates the output sequence, it may query the encoder's hidden states at each step. An attention mechanism may determine which parts of the input sequence are most relevant for generating each output element. Some embodiments may use self-attention within the encoder or decoder. This approach may allow the model to consider relationships between different time steps in the input or output sequence, potentially capturing complex temporal dependencies. In certain cases, multi-head attention may be employed. This technique may allow the model to attend to different aspects of the input simultaneously, potentially capturing various types of temporal patterns or relationships. In some embodiments, autoencoder 502 may incorporate hierarchical attention mechanisms. This approach may involve applying attention at different temporal scales, potentially allowing the model to capture both local and global temporal patterns.

Using attention in the temporal autoencoder (e.g., 502) can provide several potential benefits to processing time series data. For example, attention mechanisms may allow the model to selectively focus on the most relevant parts of the input sequence when encoding or decoding temporal data. This selective focus may help the model capture important temporal dependencies more effectively. By using attention, temporal autoencoders may be better equipped to handle long-range dependencies in time series data. The attention mechanism may allow the model to directly consider information from distant time steps, potentially overcoming limitations of traditional recurrent architectures. The attention weights generated by the model may provide insights into which parts of the input sequence are most important for reconstruction or prediction tasks. This interpretability may be valuable for understanding the model's decision-making process. Attention mechanisms may allow the model to adaptively adjust its focus based on the specific characteristics of each input sequence. This flexibility may enable the model to handle diverse temporal patterns more effectively. By leveraging attention to focus on the most relevant temporal information, the autoencoder may potentially achieve higher quality reconstructions of the input time series data.

It should be appreciated that the method 500 is merely an example, which should not unduly limit the scope of the claims. One of ordinary skill in the art would recognize many variations, alternatives, and modifications. In the illustrative embodiment, components of the method 500 are inputted into a computing device (e.g., a server 706) in order to receive a predicted trip data 518.

FIG. 6 is an exemplary diagram 600 illustrating predicting driving behavior of a targeted demographic group of users in Arizona based at least in part upon existing trip data of a similar demographic group of users in Rhode Island according to certain embodiments of the present disclosure. In the illustrative example, Rhode Island is the reference region and Arizona is the target region.

For example, an operator wants to predict driving behavior of a targeted sociodemographic group of users in Arizona. However, there is insufficient trip data (e.g., telematics data and context data) of users that have been collected in Arizona for such prediction. As such, the operator may select a reference region that has sufficient trip data of reference trips that users have taken in the corresponding reference region. In this example, the operator selects Rhode Island, which has sufficient existing trip data of a similar sociodemographic group of users.

To do so, sociodemographic distribution of the users in Rhode Island is determined. For example, the sociodemographic variables include age, gender, social class, education level, migration background, relationship status, parental status, employment status, and town size. Sociodemographic studies have shown that occupational status and education level seems to be important determination of driver injury risk. The users in Rhode Island that have similar sociodemographic data are assigned to the same cluster. The geographical area associated with each sociodemographic cluster of users is referred to as a subgroup of users in Rhode Island. Subsequently, based on the sociodemographic clusters in Rhode Island, a subgroup in Rhode Island that is similar to the targeted sociodemographic group of users in Arizona is determined and selected.

Subsequently, synthetic trips for users in the targeted sociodemographic group in Arizona are generated based at least in part upon the trip data associated with the reference trips taken by the selected subgroup of users in Rhode Island. More specifically, one or more synthetic trips are generated for each user of the targeted sociodemographic group in Arizona. For example, a synthetic trip is generated for a user of the targeted sociodemographic group in Arizona based on road condition, road type, and trip distance and/or duration of a reference trip taken by a user of the selected subgroup of users in Rhode Island. In other words, a synthetic trip includes road condition(s), road type(s), and trip distance and/or duration similar to at least one reference trip taken by a user of the selected subgroup of users in Rhode Island. According to some embodiments, a number of generated synthetic trips is the same or even higher or lower as a number of reference trips taken by the users of the selected subgroup of users in Rhode Island.

For each synthetic trip, predicted driving behaviors of the targeted sociodemographic group of users in Arizona is determined by predicting telematics data of each synthetic trip using a simulation model. As an example, the driving behavior represents a manner in which a user has operated a vehicle. For example, the user driving behavior indicates the driving habits and/or driving patterns of the user. In other words, driving habits and/or driving patterns of the targeted sociodemographic group of users in Arizona is predicted based driving habits and/or driving patterns of a similar sociodemographic group of users in Rhode Island.

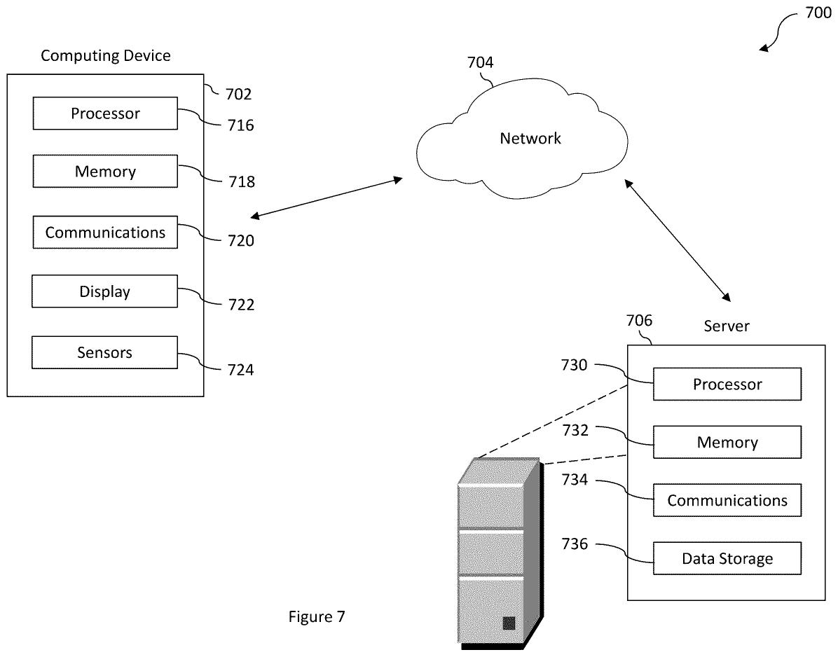

FIG. 7 is a simplified diagram showing a system for performing feature extraction of telematics data and/or predicted driving behaviors of a selected demographic group of users in a target region, according to certain embodiments of the present disclosure. This diagram is merely an example, which should not unduly limit the scope of the claims. One of ordinary skill in the art would recognize many variations, alternatives, and modifications. In the illustrative embodiment, the system 700 includes a computing device 702, a network 704, and a server 706. Although the above has been shown using a selected group of components for the system, there can be many alternatives, modifications, and variations. For example, some of the components may be expanded and/or combined. Other components may be inserted to those noted above. Depending upon the embodiment, the arrangement of components may be interchanged with others or replaced.

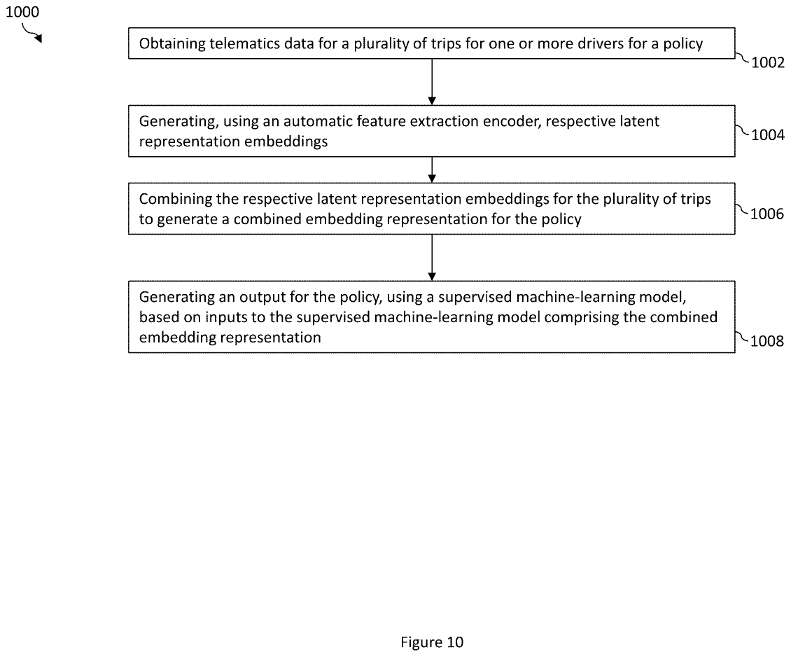

In various embodiments, the system 700 is used to implement the method 100 (FIG. 1), the method 200 (FIG. 2), the method 300 (FIG. 3), and/or the method 1000 (FIG. 10, described below). According to certain embodiments, the computing device 702 is communicatively coupled to the server 706 via the network 704. The computing device 702 may be a mobile device or a vehicle system. As an example, the computing device 702 includes one or more processors 716 (e.g., a central processing unit (CPU), a graphics processing unit (GPU)), a memory 718 (e.g., random-access memory (RAM), read-only memory (ROM), flash memory), a communications unit 720 (e.g., a network transceiver), a display unit 722 (e.g., a touchscreen), and one or more sensors 724 (e.g., an accelerometer, a gyroscope, a magnetometer, a location sensor). For example, the one or more sensors 724 are configured to generate sensor data. According to some embodiments, the data are collected continuously, at predetermined time intervals, and/or based on a triggering event (e.g., when each sensor has acquired a threshold amount of sensor measurements).

In some embodiments, the computing device 702 is operated by the user (driver). For example, the user installs an application associated with an insurer on the computing device 702 and allows the application to communicate with the one or more sensors 724 to collect sensor data. According to some embodiments, the application collects the sensor data continuously, at predetermined time intervals, and/or based on a triggering event (e.g., when each sensor has acquired a threshold amount of sensor measurements). In certain embodiments, the sensor data represents the driver's activity/behavior, such as the user driving behavior, in method 100 (FIG. 1), the method 200 (FIG. 2), the method 300 (FIG. 3), and/or the method 1000 (FIG. 10, described below).

According to certain embodiments, the collected data are stored in the memory 718 before being transmitted to the server 706 using the communications unit 720 via the network 704 (e.g., via a local area network (LAN), a wide area network (WAN), the Internet). In some embodiments, the collected data are transmitted directly to the server 706 via the network 704. In certain embodiments, the collected data are transmitted to the server 706 via a third party. For example, a data monitoring system stores any and all data collected by the one or more sensors 724 and transmits those data to the server 706 via the network 704 or a different network.

According to certain embodiments, the server 706 includes a processor 730 (e.g., a microprocessor, a microcontroller), a memory 732, a communications unit 734 (e.g., a network transceiver), and a data storage 736 (e.g., one or more databases). In some embodiments, the server 706 is a single server, while in certain embodiments, the server 706 includes a plurality of servers with distributed processing. As an example, in FIG. 7, the data storage 736 is shown to be part of the server 706. In some embodiments, the data storage 736 is a separate entity coupled to the server 706 via a network such as the network 704. In certain embodiments, the server 706 includes various software applications stored in the memory 732 and executable by the processor 730. For example, these software applications include specific programs, routines, or scripts for performing functions associated with method 100 (FIG. 1), the method 200 (FIG. 2), the method 300 (FIG. 3), and/or the method 1000 (FIG. 10, described below). As an example, the software applications include general-purpose software applications for data processing, network communication, database management, web server operation, and/or other functions typically performed by a server.

According to various embodiments, the server 706 receives, via the network 704, the sensor data collected by the one or more sensors 724 from the application using the communications unit 734 and stores the data in the data storage 736. For example, the server 706 then processes the data to perform one or more processes of method 100 (FIG. 1), the method 200 (FIG. 2), the method 300 (FIG. 3), and/or the method 1000 (FIG. 10, described below).

According to certain embodiments, the predicted driving behavior using the method 100, the method 200, and/or the method 300 is transmitted back to the computing device 702, via the network 704, to be provided (e.g., displayed) to the user via the display unit 722.

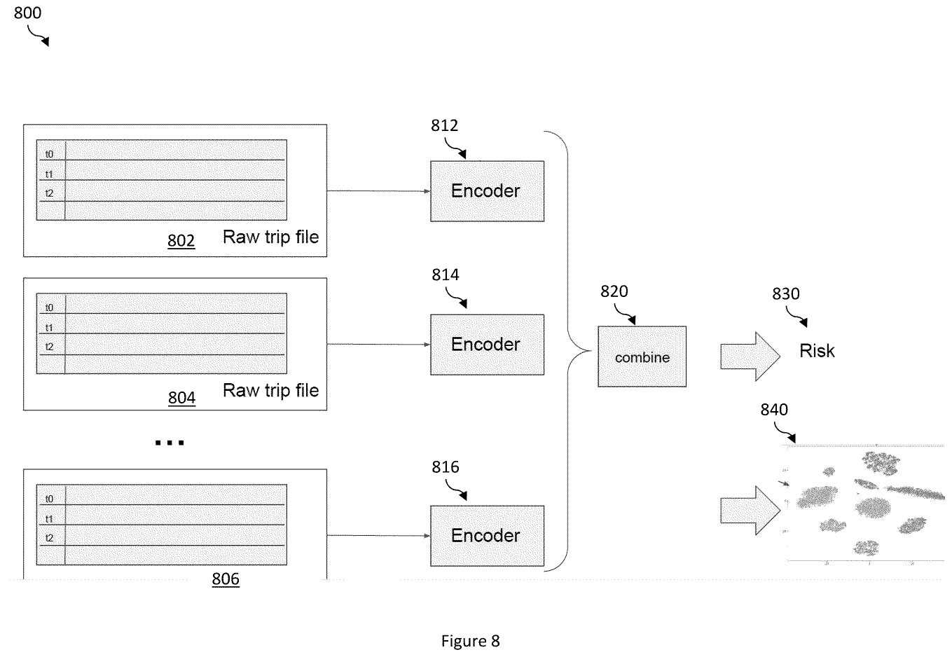

According to certain embodiments, an output of method 1000 (FIG. 10), such as a risk metric (e.g., risk metric 830 (FIG. 8, described below)), can put displayed or otherwise output by server 706 and/or computing device 702.

In some embodiments, one or more processes of method 100 (FIG. 1), the method 200 (FIG. 2), the method 300 (FIG. 3), and/or the method 1000 (FIG. 10, described below) are performed by the computing device 702. For example, the processor 716 of the computing device 702 processes the data collected by the one or more sensors 724 to perform one or more processes of method 100 (FIG. 1), the method 200 (FIG. 2), the method 300 (FIG. 3), and/or the method 1000 (FIG. 10, described below). Thus server 706 may be optional or used to receive the results from method 100 (FIG. 1), the method 200 (FIG. 2), the method 300 (FIG. 3), and/or the method 1000 (FIG. 10, described below).

FIG. 8 is a simplified diagram showing components of a method 800 for generating an output (e.g., risk metric) from raw trip data using automatic feature extraction. In many embodiments, raw trip data can be obtained, such as raw trip files 802, 804, 806, which can be for one or more drivers, such as the one or more drivers associated with an insurance policy or potential insurance policy. As described above, the telematics data associated with the trips indicates driving behaviors of a driver during trips. As an example, the driving behavior represents a manner in which the driver has operated a vehicle such as driving habits and/or driving patterns. The telematics data may be collected from one or more sensors associated with a vehicle, satellite, cameras (including street cameras), and/or a driver's mobile device. For example, the one or more sensors include any type and number of accelerometers, gyroscopes, magnetometers, location sensors (e.g., GPS sensors), and/or any other suitable sensors that measure the state and/or movement of the vehicle and/or the mobile device. In certain embodiments, the telematics data may be collected continuously or at predetermined time intervals, such as 1 ms, 100 ms, 1 second, 2 second and the like.

As described above, the trip data may further include the context data associated with the trips. The context data provides further information associated with or related to the trips. For example, the context data may include road data, user (e.g., driver) data, and/or world data. The road data associated with a trip includes information about one or more roads taken during the trip. For example, the road data includes a type of the road (e.g., highway, freeway, toll, local, or parking lot), a road map (e.g., curvature, incline, gradient, elevation, direction, and/or a number of lanes), and/or road conditions (e.g., road moisture, traffic). The user data associated with each trip of a user includes any socio-demographic information or characteristics of the user. For example, the user data includes age, race, height, weight, ethnicity, gender, marital status, income, education, employment, and/or credit score. The world data associated with each trip includes an indication whether the trip was taken on a holiday, a weather condition during the trip, and/or an indication of when the trip was taken (e.g., time of day, day of week, day of month, and/or month of year).

In many embodiments, the raw trip data can be input into an automatic feature extraction encoder (e.g., 812, 814, 816) to generate respective latent representation embeddings. In many embodiments, the automatic feature extraction encoder can be a self-supervised learning model (e.g., auto-regressive/causal language model), such as the model shown in FIG. 4 and described above, and/or a temporal autoencoder, such as the model shown in FIG. 5 and described above. In many embodiments, the automatic feature extraction encoder can be pretrained, as described above, to identify one or more patterns in driving behavior of a driver and/or extract one or more features associated with driving behavior of a driver based on the trip data of the corresponding driver.

In many embodiments, the respective latent representation embeddings can be combined at an activity 820 to generate a combined embedding representation across the collective trip data. For example, each of the latent representation embeddings can represent a respective trip of a driver on a policy, and the latent representation embeddings can be combined for all of the drivers on a policy in order to generate a combined embedding representation for the policy. In many embodiments, the combined embedding representations can represent features of the policy (or other suitable grouping of trip data).

In many embodiments, activity 820 of combining can be performed using a suitable combination technique, such as summation, element multiplication, concatenation, a multi-model technique (e.g., twin-tower embedding method, etc.), and/or other suitable methods of combination, weighted summation, weighted averaging. The combination can be a learned transformation, which can be a linear combination, a non-linear combination, and/or another suitable type of combination, such as a function of the latent representation embeddings. For example, under the concatenation approach, the vectors that include the latent representation embeddings can be concatenated, one after another. In the summation approach, vector summation can be performed on such vectors.

As an simplified example of performing the weighted averaging approach for combination, if the first vector containing the embeddings associated with a first trip can be {1,2,3,4}, the second vector containing the embeddings associated with a second trip can be {5,6,7,0}, and the third vector containing the embeddings associated with a third trip can be {1,−3, 4, 2}. A first weight associated with the first trip can be 0.5. A second weight associated with the second trip can be 0.2. A third weight associated with the third trip can be 0.3. These weights can be learned or deterministic based trip information, such as based on distance of the trip, inverse distance of the trip, geography of the trip (e.g., in-state vs. interstate), etc. In this example, the combined vector, which indicated a weighted average of the first, second, and third vectors, would be {1.8, 1.3, 4.1, 2.5}. The first element of this combined vector, 1.8, is calculated based on the summation across the multiplication of the first element of each vector by the weight for that vector.

In many embodiments, the combined embedding representation (e.g., the vector output of activity 820) can be input into a supervised machine-learning model to generate an output, which can be various different types of outputs in various different use cases. For example, the output can be a risk metric 830 for the policy associated with the trips, a classification for the policy (e.g., with or without clustering) (e.g., driver segmentation), and/or other suitable outputs.

In many embodiments, risk metric 830 can be a loss ratio, a loss amount, a number of claims, an amount of claims, or another suitable metric representing risk associated with a policy. In many embodiments, the supervised machine-learning model can be trained based on training input data including combined embedding representations generated from combined raw trips for historical policies, and training output data including risk metrics for known risk outcomes associated with the historical policies, such as the number of claims, the loss ratio associated with the policy, etc. As a simple example, the supervised machine learning model can be a linear regression model that determines the risk metric based on weights associated with element of the vector for the combined embedding representation. For example, if the combined embedding representation is stored in a vector with elements {v₁, v₂, v₃, and v₄}, and the learned weights of the linear regression model are w₁, w₂, w₃, and w₄, then the risk metric can be calculated as follows:

$$risk = {v}_{1} {w}_{1} + {v}_{2} {w}_{2} + {v}_{3} {w}_{3} + {v}_{4} {w}_{4} + b$$

where b is a learned parameter of the linear regression model. In other embodiments, the model used in activity 820 of combining can include the supervised machine-learning model, such that the risk metric is generated as part of the combination.

The risk metric can be used in various different ways. For example, in many embodiments, the risk metric can be used for to determine premiums, discounts, etc. for the insurance policy (or potential insurance policy). In other embodiments, the risk metric can be used in lead generation to determine drivers that have a certain type of risk profile.

In many embodiments, a clustering 840 of policies (or other suitable combinations of trips, as combined in activity 820) can be generated based on the combined embedding representations for the policy (or other grouping of trips), to determine types of driving associated with various different policies, such that the policies can be categorized based on the latent embeddings learned by the autoencoders, as combined across the policy. In some embodiments, a suitable clustering machine-learning model, such as k-nearest neighbors, k-means, hierarchical, mean shift, gaussian mixture model (GMM), DBSCAN, BIRCH, spectral clustering, etc. In many embodiments, the clusters can be labeled and used to create a supervised classification model, which can then be used to generate an output classification for a policy. The supervised classification model can be a binary classification, a multi-class classification, a decision tree model, a logistic regression model, a naïve-bayes model, a random forest model, a neural network, etc. In many embodiments, the training of the various models can be a fine tuning based on the use case.

It should be appreciated that the method 800 is merely an example, which should not unduly limit the scope of the claims. One of ordinary skill in the art would recognize many variations, alternatives, and modifications. For example, although the grouping of trips is described as based on policy, other suitable groupings can be used, such as by driver, by geography, by socio-demographic variables, etc.

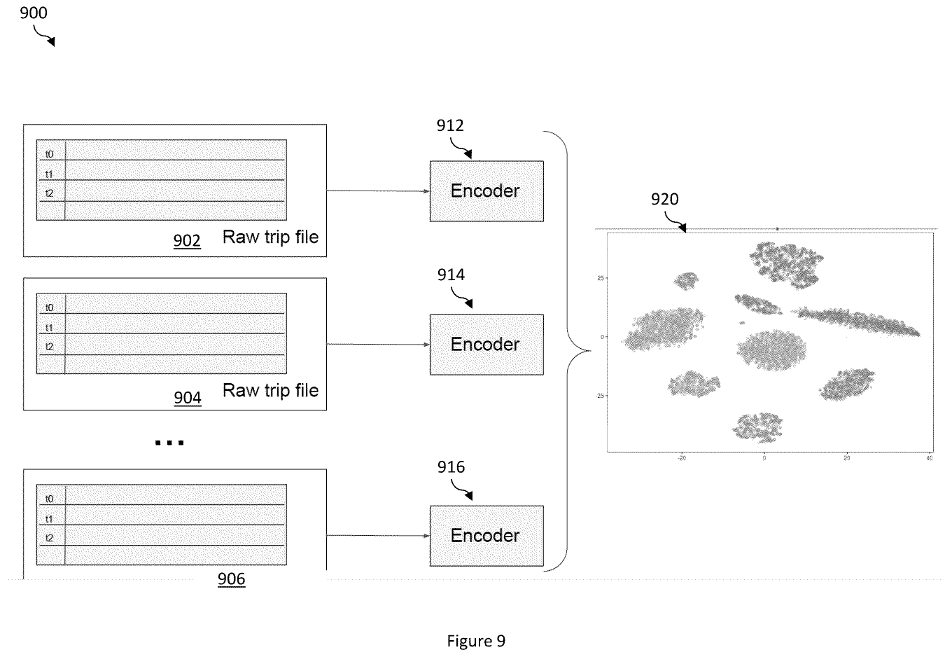

FIG. 9 is a simplified diagram showing components of a method 900 for generating a clustering of trips based on raw trip data. In many embodiments, raw trip data can be obtained, such as raw trip files 902, 904, 906, which can be for one or more drivers, such as the one or more drivers associated with an insurance policy or potential insurance policy. As described above, the telematics data associated with the trips indicates driving behaviors of a driver during trips. As an example, the driving behavior represents a manner in which the driver has operated a vehicle such as driving habits and/or driving patterns. The telematics data may be collected from one or more sensors associated with a vehicle, satellite, cameras (including street cameras), and/or a driver's mobile device. For example, the one or more sensors include any type and number of accelerometers, gyroscopes, magnetometers, location sensors (e.g., GPS sensors), and/or any other suitable sensors that measure the state and/or movement of the vehicle and/or the mobile device. In certain embodiments, the telematics data may be collected continuously or at predetermined time intervals, such as 1 ms, 100 ms, 1 second, 2 second and the like. In many embodiments, raw trip files 902, 904, and 906 can be similar to raw trip files 802, 804, and 806 (FIG. 8).

As described above, the trip data may further include the context data associated with the trips. The context data provides further information associated with or related to the trips. For example, the context data may include road data, user (e.g., driver) data, and/or world data. The road data associated with a trip includes information about one or more roads taken during the trip. For example, the road data includes a type of the road (e.g., highway, freeway, toll, local, or parking lot), a road map (e.g., curvature, incline, gradient, elevation, direction, and/or a number of lanes), and/or road conditions (e.g., road moisture, traffic). The user data associated with each trip of a user includes any socio-demographic information or characteristics of the user. For example, the user data includes age, race, height, weight, ethnicity, gender, marital status, income, education, employment, and/or credit score. The world data associated with each trip includes an indication whether the trip was taken on a holiday, a weather condition during the trip, and/or an indication of when the trip was taken (e.g., time of day, day of week, day of month, and/or month of year).

In many embodiments, the raw trip data can be input into an automatic feature extraction encoder (e.g., 912, 914, 916) to generate respective latent representation embeddings. In many embodiments, the automatic feature extraction encoder can be a self-supervised learning model (e.g., auto-regressive/causal language model), such as the model shown in FIG. 4 and described above, and/or a temporal autoencoder, such as the model shown in FIG. 5 and described above. In many embodiments, the automatic feature extraction encoder can be pretrained, as described above, to identify one or more patterns in driving behavior of a driver and/or extract one or more features associated with driving behavior of a driver based on the trip data of the corresponding driver. In many embodiments, encoders 912, 914, and 916 can be similar to encoders 812, 814, and 816 (FIG. 8).

In many embodiments, the respective latent representation embeddings can be input into a clustering model to generate a clustering 920 of the trips, as represented in a two-dimensional embedding space as show in clustering 920 of FIG. 9. The clustering model can be any suitable clustering machine-learning model, such as k-nearest neighbors, k-means, hierarchical, mean shift, gaussian mixture model (GMM), DBSCAN, BIRCH, spectral clustering, etc.

The clustering of trips can be used in various different use cases. For example, there can be billions of trips made by millions of drivers, and these trips can be clustered into a much smaller groups of clusters, such as on the order of tens or hundreds of clusters. In some cases, each trip can be represented by the respective centroid of its respective determined cluster, which can greatly reduce the amount of data stored and/or processed in performing various operations on the trip data.

In some embodiments, driver reidentification can be performed from raw trip data based on clustering, based on how a driver drives and behaves during the trips, which can provide advantages over basing driver identification on driver-reported information (which can be inaccurate).

### III. Methods for Feature Extraction from Telematics Data For Risk Assessment and Other Use Cases

FIG. 10 is a simplified diagram showing a method 1000 for performing feature extraction of telematics data, according to certain embodiments of the present disclosure. One of ordinary skill in the art would recognize many variations, alternatives, and modifications. In some embodiments, the method 100 is performed by a computing device (e.g., a server 706).

The method 1000 includes process 1002 for obtaining telematics data for a plurality of trips for one or more drivers for a policy, process 1004 for generating, using an automatic feature extraction encoder, respective latent representation embeddings each of the plurality of trips for the one or more drivers for the policy, process 1006 for combining the respective latent representation embeddings for the plurality of trips to generate a combined embedding representation for the policy, and process 1008 for generating an output for the policy, using a supervised machine-learning model, based on inputs to the supervised machine-learning model comprising the combined embedding representation.

Specifically, at the process 1002, the telematics data can be similar or identical to raw trip files 802, 804, 806 (FIG. 8) and/or raw trip files 902, 904, 906 (FIG. 9). In the illustrative embodiment, the trip data can include telematics data and context data. The telematics data is collected during trips of one or more drivers and indicates driving behaviors of the one or more drivers during the trips. As an example, the driving behavior represents a manner in which the driver has operated a vehicle. For example, the driving behavior indicates the driver's driving habits and/or driving patterns, such as speed, braking, turning and the like. The telematics data may be collected from one or more sensors associated with a vehicle, satellite, cameras (including street cameras), and/or a driver's mobile device. For example, the one or more sensors include any type and number of accelerometers, gyroscopes, magnetometers, location sensors (e.g., GPS sensors), and/or any other suitable sensors that measure the state and/or movement of the vehicle and/or the mobile device. In certain embodiments, the telematics data may be collected continuously or at predetermined time intervals, such as 1 ms, 100 ms, 1 second, 2 second and the like.

In the illustrative embodiment, the context data includes road data, user (driver) data, and/or world data. The road data associated with a trip includes information about one or more roads taken during the trip. For example, the road data includes a type of the road (e.g., highway, freeway, toll, local, or parking lot), a road map (e.g., curvature, incline, gradient, elevation, direction, and/or a number of lanes), and/or road conditions (e.g., road moisture, traffic). The user data associated with a trip of a user includes any socio-demographic information or characteristics of the user. For example, the user data includes age, race, height, weight, ethnicity, gender, marital status, income, education, employment, and/or credit score. The world data associated with a trip includes an indication whether the trip was taken on a holiday, a weather condition during the trip, and/or an indication of when the trip was taken (e.g., time of day, day of week, day of month, and/or month of year).

At the process 1004, the automatic feature extraction encoder can be similar or identical to automatic feature extraction encoder 812, 814, 816 (FIG. 8) and/or automatic feature extraction encoder 912, 914, 916 (FIG. 9). In some embodiments, the automatic feature extraction encoder can include a self-supervised learning model, such as self-supervised learning model 402 (FIG. 4), which can be an auto-regressive and/or causal language model. In other embodiments, the automatic feature extraction encoder can include a temporal autoencoder, such as autoencoder 502 (FIG. 5). In many embodiments, the temporal autoencoder uses attention mechanisms for each time-based data set of the telematics data.

At the process 1006, combining the respective latent representation embeddings for the plurality of trips to generate a combined embedding representation for the policy can be similar or identical to activity 820 (FIG. 8).

At the process 1008, the output can be a risk metric, such as risk metric 830 (FIG. 8), a classification for the policy, such as a classification based on a supervised learning model trained based on a clustering of policies, such as clustering 840 (FIG. 8). The supervised machine-learning model can be trained based on labels assigned to clusters generated by an unsupervised clustering algorithm. The classification represents a driving behavior type.

In many embodiments, method 1000 can provide advance feature extraction for risk assessment, which can leverage self-supervised learning and/or a temporal autoencoder for risk scoring. In many embodiments, the models used can be self-trained on raw trips in an unsupervised manner, and then fine-tuned in a supervised manner, which can advantageously provide for improved analysis of the trained representation space. In many embodiments, method 100 can allow for end-to-end processing from raw trips to risk scores, which can be done without manual feature engineering. In many embodiments, a dataset of raw trips can be input and scored directly, which can leverage the representation for various different use cases. In many embodiments, trip data for a new customer (without a policy yet) can be used directly (from a different domain) to onboard new customers without first building a custom model for the new customer.

Although the above has been shown using a selected group of processes for the method, there can be many alternatives, modifications, and variations. For example, some of the processes may be expanded and/or combined. Other processes may be inserted to those noted above. Depending upon the embodiment, the sequence of processes may be interchanged with others or replaced. For example, although the method 1000 is described as performed by the computing device above, some or all processes of the method are performed by any computing device or a processor directed by instructions stored in memory. As an example, some or all processes of the method are performed according to instructions stored in a non-transitory computer-readable medium.

### IV. Examples of Certain Embodiments of the Present Disclosure

According to some embodiments, a method for determining driving behaviors of a target user in a target region includes receiving a selection of a reference region and receiving a selection of a target region. The reference region has sufficient trip data of reference users collected in the reference region, and the target region has insufficient trip data of target users collected in the target region. The method further includes determining a subgroup of target users in the target region that is similar to a subgroup of reference users in the reference region based on sociodemographic information. The target subgroup of users includes the target user. The method further includes generating a plurality of synthetic trips for the target user based at least in part upon trip data associated with reference trips taken by the similar subgroup of reference users in the reference region, selecting, by the computing device, a subset of synthetic trips from the plurality of synthetic trips that are similar to the reference trips, and determining predicted driving behaviors of the target user in the target region based on the subset of synthetic trips using a simulation model. For example, the method is implemented according to at least FIG. 1, FIGS. 2A, 2B and 2C, and/or FIG. 3.

According to certain embodiments, a computing device for determining driving behaviors of a target user in a target region includes a processor and a memory having a plurality of instructions stored thereon that, when executed by the processor. The instructions, when executed, cause the one or more processors to receive a selection of a reference region and receive a selection of a target region. The reference region has the sufficient trip data of reference users collected in the reference region, and the target region has insufficient trip data of target users collected in the target region. Also, the instructions, when executed, cause the one or more processors to determine a subgroup of target users in the target region that is similar to a subgroup of reference users in the reference region based on sociodemographic information. The target subgroup of users includes the target user. Additionally, the instructions, when executed, cause the one or more processors to generate a plurality of synthetic trips for the target user based at least in part upon trip data associated with reference trips taken by the similar subgroup of reference users in the reference region, select a subset of synthetic trips from the plurality of synthetic trips that are similar to the reference trips, and determine predicted driving behaviors of the target user in the target region based on the subset of synthetic trips using a simulation model. For example, the computing device is implemented according to at least FIG. 7.

According to some embodiments, a non-transitory computer-readable medium stores instructions for determining driving behaviors of a target user in a target region. The instructions are executed by one or more processors of a computing device. The non-transitory computer-readable medium includes instructions receive a selection of a reference region and a selection of a target region. The reference region has sufficient trip data of reference users collected in the reference region, and the target region has insufficient trip data of target users collected in the target region. Also, the non-transitory computer-readable medium includes instructions to determine a subgroup of target users in the target region that is similar to a subgroup of reference users in the reference region based on sociodemographic information. The subgroup of target users includes the target user. Additionally, the non-transitory computer-readable medium includes instructions to generate a plurality of synthetic trips for the target user based at least in part upon trip data associated with reference trips taken by the similar subgroup of reference users in the reference region, select a subset of synthetic trips from the plurality of synthetic trips that are similar to the reference trips, and determine predicted driving behaviors of the target user in the target region based on the subset of synthetic trips using a simulation model. For example, the non-transitory computer-readable medium is implemented according to at least FIG. 1, FIGS. 2A, 2B and 2C, and/or FIG. 3.

According to some embodiments, a method for feature extraction from telematics data. The method includes obtaining telematics data for a plurality of trips for one or more drivers for a policy. The method also includes generating, using an automatic feature extraction encoder, respective latent representation embeddings each of the plurality of trips for the one or more drivers for the policy. The method additionally includes combining the respective latent representation embeddings for the plurality of trips to generate a combined embedding representation for the policy. The method further includes generating an output for the policy, using a supervised machine-learning model, based on inputs to the supervised machine-learning model comprising the combined embedding representation. For example, the method is implemented according to at least FIG. 10.

According to some embodiments, a system comprising one or more processors and one or more non-transitory computer-readable media storing computing instructions that, when executed on the one or more processors, cause the one or more processors to perform certain operations. The operations include obtaining telematics data for a plurality of trips for one or more drivers for a policy. The operations also include generating, using an automatic feature extraction encoder, respective latent representation embeddings each of the plurality of trips for the one or more drivers for the policy. The operations additionally include combining the respective latent representation embeddings for the plurality of trips to generate a combined embedding representation for the policy. The operations further include generating an output for the policy, using a supervised machine-learning model, based on inputs to the supervised machine-learning model comprising the combined embedding representation. For example, the system is implemented according to at least FIG. 7.

According to some embodiments, one or more non-transitory computer-readable media storing computing instructions that, when executed on one or more processors, cause the one or more processors to perform certain operations. The operations include obtaining telematics data for a plurality of trips for one or more drivers for a policy. The operations also include generating, using an automatic feature extraction encoder, respective latent representation embeddings each of the plurality of trips for the one or more drivers for the policy. The operations additionally include combining the respective latent representation embeddings for the plurality of trips to generate a combined embedding representation for the policy. The operations further include generating an output for the policy, using a supervised machine-learning model, based on inputs to the supervised machine-learning model comprising the combined embedding representation. For example, the one or more non-transitory computer-readable media is implemented according to at least FIG. 10.

### V. Examples of Machine Learning According to Certain Embodiments

According to some embodiments, a processor or a processing element may be trained using supervised machine learning and/or unsupervised machine learning, and the machine learning may employ an artificial neural network, which, for example, may be a convolutional neural network, a recurrent neural network, a deep learning neural network, a reinforcement learning module or program, or a combined learning module or program that learns in two or more fields or areas of interest. Machine learning may involve identifying and recognizing patterns in existing data in order to facilitate making predictions for subsequent data. Models may be created based upon example inputs in order to make valid and reliable predictions for novel inputs.

According to certain embodiments, machine learning programs may be trained by inputting sample data sets or certain data into the programs, such as images, object statistics and information, historical estimates, and/or actual repair costs. The machine learning programs may utilize deep learning algorithms that may be primarily focused on pattern recognition and may be trained after processing multiple examples. The machine learning programs may include Bayesian Program Learning (BPL), voice recognition and synthesis, image or object recognition, optical character recognition, and/or natural language processing. The machine learning programs may also include natural language processing, semantic analysis, automatic reasoning, and/or other types of machine learning.

According to some embodiments, supervised machine learning techniques, unsupervised machine learning techniques, and/or self-supervised machine learning techniques may be used. In supervised machine learning, a processing element may be provided with example inputs and their associated outputs and may seek to discover a general rule that maps inputs to outputs, so that when subsequent novel inputs are provided the processing element may, based upon the discovered rule, accurately predict the correct output. In unsupervised machine learning, the processing element may need to find its own structure in unlabeled example inputs. Similar to the unsupervised machine learning, in self-supervised machine learning, the processing element may need to find its own structure in unlabeled example inputs. However, the self-supervised machine learning has a lot of supervisory signals that may act as feedback in the training process.

### VI. Additional Considerations According to Certain Embodiments

For example, some or all components of various embodiments of the present disclosure each are, individually and/or in combination with at least another component, implemented using one or more software components, one or more hardware components, and/or one or more combinations of software and hardware components. As an example, some or all components of various embodiments of the present disclosure each are, individually and/or in combination with at least another component, implemented in one or more circuits, such as one or more analog circuits and/or one or more digital circuits. For example, while the embodiments described above refer to particular features, the scope of the present disclosure also includes embodiments having different combinations of features and embodiments that do not include all of the described features. As an example, various embodiments and/or examples of the present disclosure can be combined.

Additionally, the methods and systems described herein may be implemented on many different types of processing devices by program code comprising program instructions that are executable by the device processing subsystem. The software program instructions may include source code, object code, machine code, or any other stored data that is operable to cause a processing system to perform the methods and operations described herein. Certain implementations may also be used, however, such as firmware or even appropriately designed hardware configured to perform the methods and systems described herein.

The systems' and methods' data (e.g., associations, mappings, data input, data output, intermediate data results, final data results) may be stored and implemented in one or more different types of computer-implemented data stores, such as different types of storage devices and programming constructs (e.g., RAM, ROM, EEPROM, Flash memory, flat files, databases, programming data structures, programming variables, IF-THEN (or similar type) statement constructs, application programming interface). It is noted that data structures describe formats for use in organizing and storing data in databases, programs, memory, or other computer-readable media for use by a computer program.

The systems and methods may be provided on many different types of computer-readable media including computer storage mechanisms (e.g., CD-ROM, diskette, RAM, flash memory, computer's hard drive, DVD) that contain instructions (e.g., software) for use in execution by a processor to perform the methods' operations and implement the systems described herein. The computer components, software modules, functions, data stores and data structures described herein may be connected directly or indirectly to each other in order to allow the flow of data needed for their operations. It is also noted that a module or processor includes a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

The computing system can include mobile devices and servers. A mobile device and server are generally remote from each other and typically interact through a communication network. The relationship of mobile device and server arises by virtue of computer programs running on the respective computers and having a mobile device-server relationship to each other.

This specification contains many specifics for particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations, one or more features from a combination can in some cases be removed from the combination, and a combination may, for example, be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Although specific embodiments of the present disclosure have been described, it will be understood by those of skill in the art that there are other embodiments that are equivalent to the described embodiments. Accordingly, it is to be understood that the present disclosure is not to be limited by the specific illustrated embodiments.

1. A computer-implemented method comprising:
obtaining telematics data for a plurality of trips for one or more drivers for a policy;
generating, using an automatic feature extraction encoder, respective latent representation embeddings each of the plurality of trips for the one or more drivers for the policy;
combining the respective latent representation embeddings for the plurality of trips to generate a combined embedding representation for the policy; and
generating an output for the policy, using a supervised machine-learning model, based on inputs to the supervised machine-learning model comprising the combined embedding representation.

2. The computer-implemented method of claim 1, wherein the output comprises a risk metric for the policy.

3. The computer-implemented method of claim 1, wherein the output comprises a classification for the policy performed by the supervised machine-learning model.

4. The computer-implemented method of claim 3, wherein the supervised machine-learning model is trained based on labels assigned to clusters generated by an unsupervised clustering algorithm.

5. The computer-implemented method of claim 3, wherein the classification represents a driving behavior type.

6. The computer-implemented method of claim 1, wherein the automatic feature extraction encoder comprises a self-supervised learning model.

7. The computer-implemented method of claim 1, wherein the automatic feature extraction encoder comprises a temporal autoencoder.

8. The computer-implemented method of claim 7, wherein the temporal autoencoder uses attention mechanisms for each time-based data set of the telematics data.

9. A system comprising one or more processors and one or more non-transitory computer-readable media storing computing instructions that, when executed on the one or more processors, cause the one or more processors to perform operations comprising:
obtaining telematics data for a plurality of trips for one or more drivers for a policy;
generating, using an automatic feature extraction encoder, respective latent representation embeddings each of the plurality of trips for the one or more drivers for the policy;
combining the respective latent representation embeddings for the plurality of trips to generate a combined embedding representation for the policy; and
generating an output for the policy, using a supervised machine-learning model, based on inputs to the supervised machine-learning model comprising the combined embedding representation.

10. The system of claim 9, wherein the output comprises a risk metric for the policy.

11. The system of claim 9, wherein the output comprises a classification for the policy performed by the supervised machine-learning model.

12. The system of claim 11, wherein the supervised machine-learning model is trained based on labels assigned to clusters generated by an unsupervised clustering algorithm.

13. The system of claim 9, wherein the automatic feature extraction encoder comprises a self-supervised learning model.

14. The system of claim 9, wherein:
the automatic feature extraction encoder comprises a temporal autoencoder that uses attention mechanisms for each time-based data set of the telematics data.

15. One or more non-transitory computer-readable media storing computing instructions that, when executed on one or more processors, cause the one or more processors to perform operations comprising:
obtaining telematics data for a plurality of trips for one or more drivers for a policy;
generating, using an automatic feature extraction encoder, respective latent representation embeddings each of the plurality of trips for the one or more drivers for the policy;
combining the respective latent representation embeddings for the plurality of trips to generate a combined embedding representation for the policy; and
generating an output for the policy, using a supervised machine-learning model, based on inputs to the supervised machine-learning model comprising the combined embedding representation.

16. The one or more non-transitory computer-readable media of claim 15, wherein the output comprises a risk metric for the policy.

17. The one or more non-transitory computer-readable media of claim 15, wherein the output comprises a classification for the policy performed by the supervised machine-learning model.

18. The one or more non-transitory computer-readable media of claim 17, wherein the supervised machine-learning model is trained based on labels assigned to clusters generated by an unsupervised clustering algorithm.

19. The one or more non-transitory computer-readable media of claim 15, wherein the automatic feature extraction encoder comprises a self-supervised learning model.

20. The one or more non-transitory computer-readable media of claim 15, wherein:
the automatic feature extraction encoder comprises a temporal autoencoder that uses attention mechanisms for each time-based data set of the telematics data.
